(19) United States
(12) Patent Application Publication
(10) Pub. No.: US 2013/0086274 A1
(43) Pub. Date: Apr. 4, 2013

(54) Timing Management for Implementing Smarter Decisions in Time-Constrained Complex Distribution Systems

(71) Applicants: Bhavesh Goswami, Seattle, WA (US); Gerhard Geldenbott, Seattle, WA (US); Salman Ali, Issaquah, WA (US); Arpita Saha, Redmond, WA (US); Yi-Min Flora Chua, Issaquah, WA (US); Andy Hazzard, Seattle, WA (US)

(72) Inventors: Bhavesh Goswami, Seattle, WA (US); Gerhard Geldenbott, Seattle, WA (US); Salman Ali, Issaquah, WA (US); Arpita Saha, Redmond, WA (US); Yi-Min Flora Chua, Issaquah, WA (US); Andy Hazzard, Seattle, WA (US)

(21) Appl. No.: 13/632,326

(22) Filed: Oct. 1, 2012

Related U.S. Application Data
(60) Provisional application No. 61/541,659, filed on Sep. 30, 2011.

(51) Int. Cl. G06F 15/16

(52) U.S. Cl. 709/230

(57) ABSTRACT

A timing management node that assigns and adjusts timeout values for a time-constrained complex distributed system based on the nature of a system request, preferences of a customer furnishing a system request, and/or a current state of a complex distributed system. A timing management node evaluates information regarding a system request and information regarding a current state of a complex distributed system to generate timing requirements for the system request. Timing requirements are compiled in a timing policy messager and passed amongst nodes of a complex distributed system with process flow. Timing requirements may be revised during request processing to reflect events that have occurred within the distributed system. A timing policy message contains a timeout value and a total time elapsed parameter for a system request, to permit a complex distributed system to make smarter processing decisions based on a known time remaining to process the given system request.

The present invention claims priority from U.S. Provisional Application No. 61/541,659 to Goswami et al., entitled “Timing Management for Implementing Smarter Decisions in Time-Constrained Complex Distributed Systems” filed Sep. 30, 2011, the entirety of which is expressly incorporated by reference.

### BACKGROUND OF THE INVENTION

1. Field of the Invention

This invention relates generally to communications. More particularly, it relates to distributed emergency call systems.

2. Background of Related Art

A complex distributed system is comprised of a collection (i.e. 2 or more) of nodes (e.g., computers, devices, modules, processes, etc.) that interact with one another via messaging to complete and respond to a common system request. A system request conventionally consists of a computational task furnished to a complex distributed system via an external entity. A system request received on a complex distributed system is divided in to several subtasks, and each subtask is performed on a separate node of the complex distributed system. A complex distributed system then pools results achieved on individual system nodes to complete and respond to a given system request. A distributed system may be, e.g., a network of computers, devices, etc., physically distributed over a geographic area (e.g. the Internet, a banking system, etc.), or a number of processes running on a single computer, device, etc., e.g., an operating system.

Timeout values are conventionally defined for a complex distributed system, to ensure that system requests are carried out in a timely manner. A timeout value is a maximum period of time allotted to processing any given system request in a complex distributed system. Conventionally, one global timeout value may be defined for an entire complex distributed system or individual timeout values may be defined for each node of a complex distributed system.

If a timeout value is reached before a complex distributed system is through processing a system request, the relevant system request is terminated to ensure that request processing does not ensue indefinitely. If timeout values are applied to individual nodes of a distributed system, each individual node must finish processing a request before a designated timeout value is reached, to permit the entire distributed system to respond to that system request successfully. An appropriate error message is transmitted in response to a system request that is not completed in time.

Timeout values defined for a complex distributed system are conventionally static (i.e. fixed at one particular value) for all system requests and all customers that furnish system requests to a complex distributed system. Moreover, a timeout value defined for a complex distributed system is conventionally static throughout request processing. Unfortunately, static timeout values are limited in efficiency because they do not take the nature of any particular system request in to account. For instance, static timeout values defined for a complex distributed system do not account for system requests that require significantly more or less time to complete than others. Moreover, static timeout values applied to complex distributed systems do not accommodate customers that require different response times to identical system requests. Further, timeout values that are static throughout request processing do not account for critical events that affect the performance of a complex distributed system. Further yet, a complex distributed system does not provide downstream distributed systems with information regarding timing adjustments necessary in upstream nodes nor information regarding upstream errors.

Timeout values play a critical role in the performance of a time-constrained complex distributed system. If a timeout value is set too large, excessive delay may transpire before an error message is transmitted in response to a failed system request. Moreover, if a timeout value is set too small, system requests that require long processing times may be terminated prematurely. The present inventors have appreciated that there is a need for a timing management system that dynamically assigns and adjusts timeout values for a time-constrained complex distributed system.

### SUMMARY OF THE INVENTION

In accordance with the principles of the present invention, a timing management system and apparatus assigns and adjusts timing requirements (e.g. timeout values) for a time-constrained complex distributed system based on the nature of a given system request, preferences of a customer furnishing a system request, and/or a current state of a complex distributed system. Nodes of a complex distributed system send timing queries to a timing management node to request timing requirements (e.g. timeout values) for a given system request. The timing management node evaluates information relevant to a particular system request and information pertaining to a current state of a complex distributed system to determine appropriate timing requirements.

In accordance with another aspect of the present invention, a timing management node compiles timing requirements generated for a system request received on a complex distributed system in to a timing policy message. The timing policy message generated by the timing management node is passed amongst nodes of a complex distributed system with process flow. During request processing, any node of a complex distributed system may query the timing management node to request up-to-date timing requirements. Timing requirements may be modified during request processing to reflect a current state of a distributed system.

A timing policy message contains a timeout value and a total time elapsed parameter for a corresponding system request. A timeout value defines a maximum amount of time allotted to processing a given system request. Moreover, a total time elapsed parameter represents a total time elapsed since a system request has entered a distributed system. A timeout value and a total time elapsed parameter influence nodes of a complex distributed system to make smarter processing decisions, based on a known amount of time remaining to process a given system request.

### BRIEF DESCRIPTION OF THE DRAWINGS

Features and advantages of the present invention become apparent to those skilled in the art from the following description with reference to the drawings:

FIG. 1 depicts exemplary implementation of a timing management node in a complex distributed system, in accordance with the principles of the present invention.

FIG. 2 depicts exemplary implementation of a timing management node in an emergency call system, in accordance with the principles of the present invention.

### DETAILED DESCRIPTION OF ILLUSTRATIVE EMBODIMENTS

The present invention provides a timing management system for a time-constrained complex distributed system. The timing management system disclosed herein permits timing requirements (e.g. timeout values) to be assigned to a complex distributed system, or to individual nodes of a complex distributed system, based on the nature of a given system request, preferences of a customer furnishing a system request, and/or a current state of a complex distributed system. Moreover, the inventive timing management system permits a timeout value to be modified during request processing so that an optimal timeout value may always be achieved. Furthermore, the inventive timing management system furnishes a timeout value and a total time elapsed parameter for a given system request, to each individual node of a complex distributed system. Inventive parameters influence a complex distributed system to make smarter processing decisions based on a known amount of time remaining to process a given system request.

In accordance with the principles of the present invention, timing management is implemented in a complex distributed system via a timing management node. In particular, nodes of a complex distributed system send timing queries to a timing management node to request timing requirements for a given system request. A timing query prompts a timing management node to generate appropriate timing requirements (e.g. timeout values) for a complex distributed system. Timing requirements generated by a timing management node are compiled in to a timing policy message and returned to a system node in response to a timing query.

Timing requirements in a timing policy message preferably comprise one global timeout value for an entire complex distributed system or separate timeout values for each individual node of a complex distributed system (as is deemed appropriate). Moreover, a timing policy message preferably includes data regarding critical events that have taken place within the distributed system, and any other data that may affect future timing decisions. In addition, a timing policy message contains a total time elapsed parameter that represents a total time elapsed since a system request has entered a complex distributed system. A timeout value and a total time elapsed parameter advise nodes of a complex distributed system as to how much time remains to process a given system request.

A timing policy message is passed amongst nodes of a complex distributed system with process flow. Throughout request processing, any node of a complex distributed system may send a timing query to a timing management node to request up-to-date timing requirements. Depending upon a current state of a complex distributed system and circumstances relevant to a corresponding system request, the timing management node may or may not revise timing requirements in response to a timing query furnished during request processing.

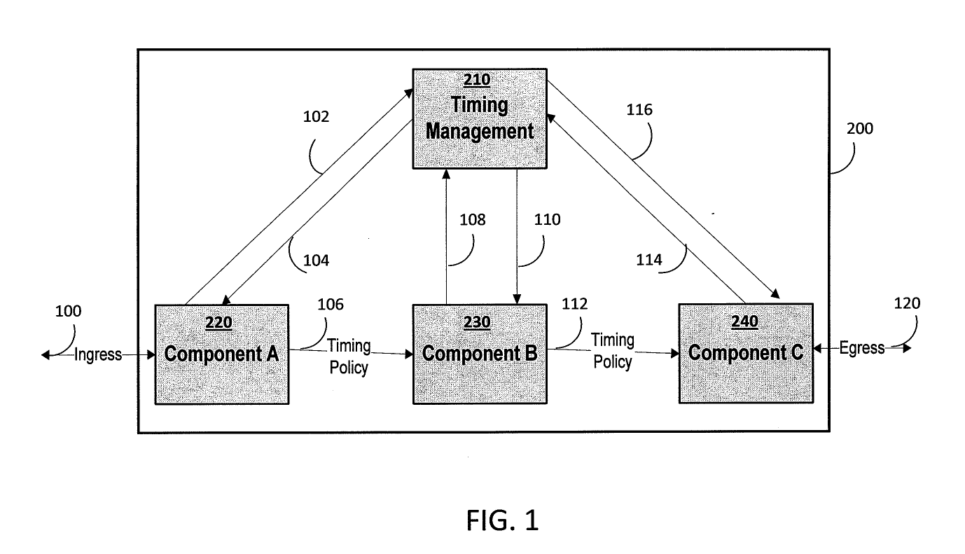

FIG. 1 depicts exemplary implementation of a timing management node in a complex distributed system, in accordance with the principles of the present invention.

As depicted in step 100 of FIG. 1, a system request is received on component A 220 of a complex distributed system 200 from an entity external to the system 200. Upon receiving the system request, component A 220 sends a timing query to a timing management node 210, as portrayed in step 102. The timing query preferably comprises information pertaining to the system request received in step 100 (e.g. the nature of the system request, timing preferences of customers furnishing the system request, etc.), and any relevant information regarding the current state of the complex distributed system 200 (e.g. information regarding critical events that may affect timing decisions). The timing management node 210 receives the timing query and analyzes data compiled therein to determine appropriate timing requirements for the complex distributed system 200. Timing requirements are preferably generated via a decision making engine within the timing management node 210.

In accordance with the principles of the present invention, the timing management node 210 may either generate global timing requirements (e.g. timeout values) for the entire distributed system 200, or separate timing requirements for each individual node (220, 230, and 240) of the distributed system 200. For example, the timing management node 210 might allocate x milliseconds for component A 220 to finish all of its procession, y milliseconds for component B 230, and z milliseconds for component C 240. Alternatively, the timing management node 210 might allocate t milliseconds for the entire distributed system 200 to finish all of its procession.

In step 104, the timing management node 210 assembles timing requirements relevant to the current system request (received in step 100) in to a timing policy message and transmits the timing policy message to component A 220.

Component A 220 receives the timing policy message and carries out request-related operations, in accordance with timing restrictions imposed by the timing management node 210. Once request processing has concluded on component A 220, component A 220 augments the timing policy message generated for the system request, to include all (or part) of the timing information originally assembled therein, as well as any additional information (e.g. information regarding critical events that have occurred within the distributed system 200) that may impact future timing decisions.

In step 106, component A 220 sends the newly compiled timing policy message with process flow to component B 230 (i.e. a subsequent system node). Upon receipt, component B 230 may either process the system request in accordance with the timing policy message received with process flow, or send a timing query to the timing management node 210 to request reconsideration of timing requirements (step 108). Action taken by component B 230 depends upon circumstances of the current system request, timing information contained in the current timing policy message, the current state of the distributed system 200, and any other relevant factors.

If component B 230 proceeds to carry out request-related operations without consulting the timing management node 210, request processing is carried out in accordance with the latest timing policy message generated for the system request.

Alternatively, if component B 230 seeks further consideration from the timing management node 210, component B 230 compiles any data (e.g. data regarding the current state of the complex distributed system 200, data regarding process flow, data relevant to the system request, etc.) that may impact timing requirements conjured for the system request in to a timing query, and sends the timing query to the timing management node 210 (step 108).

The timing management node 210 receives the timing query and 210 analyzes information compiled therein to determine if a new timing policy message is required for the system request. If a new timing policy message is required, the timing management node 210 revises timeout values compiled in the latest timing policy message generated for the system request, and sends a revised timing policy message to component B 230 (step 110). If a new timing policy message is not required, the timing management node 210 preferably sends a copy of the latest timing policy message generated for the system request to component B 230 (step 110), in response to the timing query received therefrom. Moreover, if a new timing policy message is not required, the timing management node 210 may alternatively send an appropriate message to component B 230 (step 110), in response to the timing query received therefrom.

Component B 230 then carries out request-related operations, in accordance with timing restrictions outlined in the latest timing policy message generated for the system request.

Once request processing has concluded on component B 230, component B 230 augments the latest timing policy message generated for the system request to include all (or part) of the timing information originally assembled therein, as well as any additional information (e.g. information regarding critical events that have occurred within the distributed system 200) that may impact future timing decisions. In step 112, component B 230 sends the newly compiled timing policy message with process flow to component C 240 (i.e. a subsequent system node).

Component C 240 is the last node to process the system request in the complex distributed system 200 depicted in FIG. 1. As previously disclosed, component C 240 may either process the system request in accordance with the timing policy message received with process flow, or query the timing management node 210 (step 114) to request reconsideration of timing requirements.

If component C 240 seeks reconsideration from the timing management node, component C 240 compiles any data (e.g. data regarding the current state of the complex distributed system 200, data regarding process flow, data relevant to the system request, etc.) that may impact timing requirements conjured for the system request in to a timing query, and sends the timing query to the timing management node 210 (step 114).

In response to the timing query (step 116), the timing management node 210 may or may not issue a revised timing policy message, based on circumstances specific to the system request and the current state of the distributed system 200.

In step 120, component C 240 completes request processing and responds to the given system request, in accordance with timing requirements outlined in the latest timing policy message generated for the system request.

In accordance with the principles of the present invention, timing requirements (e.g. timeout values) defined for a complex distributed system 200 may be adjusted during request processing, to account for critical events that take place within the distributed system 200. For instance, when a system node (e.g. component A 220) takes less time than is allotted to complete request processing, a timing management node 210 may issue a revised timing policy message to a subsequent system node (e.g. component B 230) to designate the subsequent system node more time (i.e. a larger timeout value) to complete request processing, based on processing time conserved in the previous system node (e.g. component A 220).

Moreover, a system node may experience a critical error and/or discovery that requires a subsequent system node to be allocated more or less time than usual to complete request processing. The present invention permits a system node (e.g. component A 220) that experiences a critical error and/or discovery to compile information regarding that critical error and/or discovery in to a timing policy message, before passing the timing policy message to a subsequent system node (e.g. component B 230). Once the subsequent system node (e.g. component B 230) receives the timing policy message, that subsequent system node may send a timing query to the timing management node 210 to request reconsideration of timing requirements. In response to such a timing query, the timing management node 210 preferably furnishes a revised timing policy message to the subsequent system node (e.g. component B) with timing requirements (e.g. timeout values) that have been modified to account for noted critical errors and/or discoveries.

For example, if an AQS query fails in a next generation (NG) emergency call system during emergency call processing, a timing management node 210 may generate a revised timing policy message that allocates less processing time (a smaller timeout value) to an emergency services routing proxy (ESRP) (i.e. a subsequent system node in the next generation (NG) emergency call system), since an emergency services routing proxy (ESRP) does not need to perform a LoST query when an AQS query fails (i.e. a critical error occurs in a previous system node). Hence, the emergency services routing proxy (ESRP) requires less time than usual to complete request processing.

In accordance with the principles of the present invention, timeout values may be determined for a complex distributed system 200 based on an input signal, customer type, request type, time-of-day, etc., corresponding to a particular system request.

In accordance with the principles of the present invention, the timing management system disclosed herein has particular applicability to emergency call systems.

An emergency call system is a complex distributed system that bridges local government entities and call service providers, to route emergency calls to proper emergency dispatch personnel.

In particular, an emergency call system routes an emergency call to a Public Safety Answering Point (PSAP) (i.e. a dispatcher/emergency call center), where proper emergency services are subsequently administered. The emergency call system preferably routes an emergency call to a Public Safety Answering Point (PSAP) within closest geographic proximity to an originating communication device.

New technologies implemented in a next generation (NG) emergency call system (e.g. NG 9-1-1) may require an emergency call to be routed in sub-second duration, regardless as to whether or not the quality of call routing is consequently compromised.

In an emergency call system, paramount importance lies in the ability to route an emergency call to a public safety answering point (PSAP) within a predetermined threshold of time (i.e. generally a matter of seconds). If an emergency call is not routed within a maximum time-threshold, an emergency caller might mistakingly assume that an anomaly has occurred due to excessive delay, disconnect the emergency phone call, and call again. Call disconnect only prolongs the amount of time before an emergency caller reaches a public safety answering point (PSAP).

To achieve utmost efficiency, an emergency call system must balance allocating an appropriate amount of time to finding a best public safety answering point (PSAP) for call routing, with finding a public safety answering point (PSAP) for call routing within a predetermined period of time.

An emergency call system (e.g. next generation (NG) emergency call system) has numerous components. During call processing, each component must be aware of a timeout value (i.e. maximum time threshold) designated to processing a relevant emergency call, as well as a total time elapsed since call origination (i.e. total time elapsed since a call has entered the system).

A timeout value and a total time elapsed parameter enable an emergency call system (e.g. a next generation (NG) emergency call system) to make smarter processing decisions, based on how close a system is to reaching a maximum time threshold allocated to call processing. For instance, in the case that an emergency call system is not close to reaching a timeout value allocated to call processing, the emergency call system can spend more time trying to find a best public safety answering point (PSAP) to route an emergency call to. Alternatively, in the case that an emergency call system is close to reaching a timeout value allocated to call processing, the emergency call system can select a public safety answering point (PSAP) to route an emergency call to without further delay.

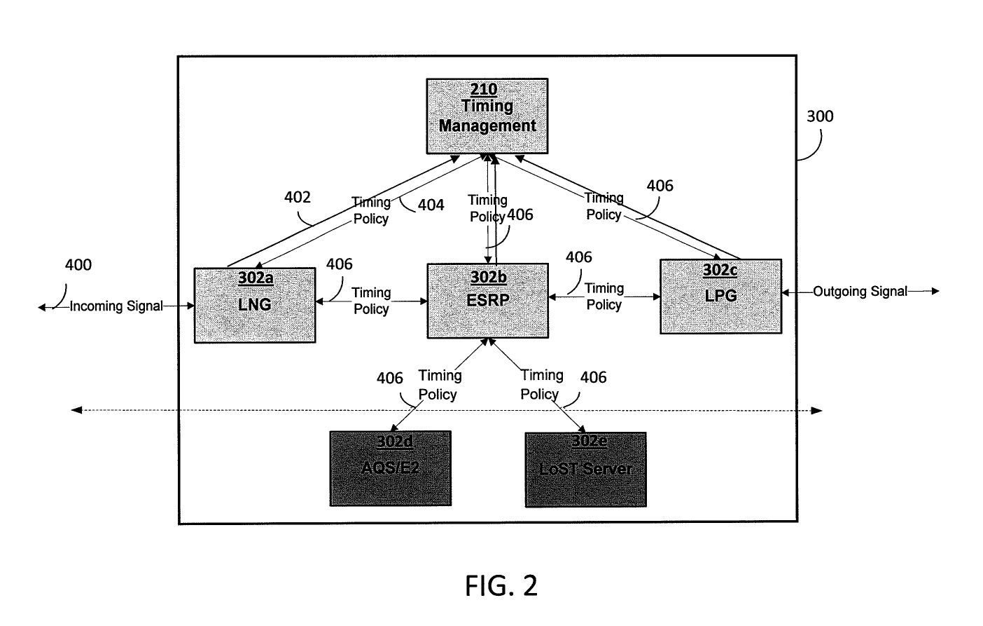

FIG. 2 depicts exemplary implementation of a timing management node in an emergency call system, in accordance with the principles of the present invention.

As depicted in step 400 of FIG. 2, an incoming call is received on an ingress node 302a of an emergency call system 300 (e.g. a next generation (NG) emergency call system) from an entity external to the system (e.g. an emergency caller). Upon receiving the incoming call, the ingress node 302a sends a timing query to the timing management node 210, as depicted in step 402. The timing query sent to the timing management node 210 preferably contains information (e.g. incoming call signal, time-of-day, customer type, etc.) regarding the incoming emergency call, and any information regarding critical events that have occurred within the emergency call system 300.

Once the timing management node 210 receives the timing query transmitted in step 402, the timing management node 210 evaluates factors regarding the current state of the complex distributed system 300 and factors regarding the incoming emergency call (e.g., an incoming signal, trunk number, caller number, etc.), to determine appropriate timing requirements (e.g. timeout values) for call processing. In accordance with the principles of the present invention, the timing management node 210 generally designates one global timeout value to an entire emergency call system 300. However, in specific cases, the timing management node 210 may designate individual timeout values to each subcomponent 302 of an emergency call system 300.

In step 404, the timing management node 110 converts timing requirements generated for the emergency call to a timing header, and transmits the timing header to a first processing node 302a in the emergency call system (e.g. a next generation (NG) emergency call system). During call processing, the timing header is passed with process flow (step 406) to each relevant node 302 of the emergency call system 300. The timing header preferably comprises a timeout value (i.e. a maximum time-threshold that should not be exceeded by the emergency call system 300 to route a relevant emergency call), and a total time elapsed parameter (i.e. time elapsed since the emergency call has entered the emergency call system 300) for the corresponding emergency call.

Each node 302 that processes the emergency call in the emergency call system 300 takes note of the timing header and augments timing information contained therein, before passing the timing header (step 406) to a subsequent system node 302 (with process flow). The timing header traverses nodes 302 of the emergency call system 300 until it is eventually routed to an appropriate public safety answering point (PSAP).

There are numerous crucial junctions in which information in a timing header will influence nodes 302 of an emergency call system 300 (e.g. a next generation (NG) emergency call system) to conjure smarter processing decisions.

For example, a location-to-service translation protocol (LoST) server 302e (i.e. a node in a next generation (NG) emergency call system) uses a timing header to make smarter processing decisions when determining an appropriate public safety answering point (PSAP) to route an emergency call to. For instance, a LoST 302e server needs to perform a fair bit of computation to identify public safety answering points (PSAPs) that correspond to a particular geometric shape. Moreover, a geometric shape could potentially be overlapped by many public safety answering points (PSAPs), depending upon the size and location of the shape. When there are multiple public safety answering points (PSAPs) associated with a given geometric shape, a LoST server 302e needs to identify a public safety answering point (PSAP) that is most relevant. Computations performed to determine a public safety answering point (PSAP) for call routing may be quite time intensive, thus a LoST server 302e refers to a timing header to make critical decisions based on a known amount of time remaining to process a relevant emergency call.

Moreover, a LoST server 302e does not spend any more time determining a relevance-order for public safety answering points (PSAPs) that correspond to a given emergency call, if a total time elapsed parameter is nearing a timeout value defined for that emergency call. If call processing time is nearing a maximum time threshold, the LoST server 302e simply sends public safety answering points (PSAPs) in an order deemed most relevant given information already attained.

A LoST server 302e is required to support redirection. At each hop, a LoST server 302e passes a timing header pertaining to a relevant emergency call to any LoST server 302e to which it is redirecting. If a timeout value allotted to call processing is reached, the LoST server 302e stops processing the relevant emergency call and sends back a response. An emergency services routing proxy (ESRP) 302b can default route in that case.

In accordance with the principles of the present information, timing information maintained in a timing header is also beneficial to an emergency services routing proxy (ESRP) 302b in an emergency call system 300 (e.g. a next generation (NG) emergency call system).

For instance, public safety answering points (PSAPs) have policy routing function (PRF) policies surrounding “Time of Day”, “Overflow”, and various other conditions that affect routing to those public safety answering points (PSAPs). Conventionally, an emergency services routing proxy (ESRP) 302b evaluates requirements articulated in policy routing function (PRF) policies and applies them when necessary. While applying policy routing function (PRF) rules, the emergency services routing proxy (ESRP) 302b keeps timeout values in context. If a timeout value allotted to call processing is near, the emergency services routing proxy (ESRP) 302b preferably stops evaluating policy routing function (PRF) rules and routes a relevant emergency call to a best possible location, based on information already gathered.

A LoST server 302e might send multiple public safety answering point (PSAP) location uniform resource identifiers (URIs) to an emergency services routing proxy (ESRP) 302b. An emergency services routing proxy (ESRP) 302b is then required to determine which URI should be used for call-routing. The emergency services routing proxy (ESRP) 302b may also determine the policy routing function (PRF) implications of a selected public safety answering point (PSAP) URI. When determining an appropriate public safety answering point (PSAP) URI, the emergency services routing proxy (ESRP) 302b keeps timeout values in context. If a timeout value allotted to call processing is near, the emergency services routing proxy (ESRP) 302b preferably stops computing more location URIs and simply routes to the best known route, given information already attained.

While the invention has been described with reference to the exemplary embodiments thereof, those skilled in the art will be able to make various modifications to the described embodiments of the invention without departing from the true spirit and scope of the invention.

What is claimed is:

1. A timing management system and apparatus that assigns and adjusts timing requirements for a time-constrained complex distributed system, comprising:
an interface to a time-constrained complex distributed system; and
a timing management node to assign and adjust a timing requirement based on a nature of a given system request.

2. The timing management system and apparatus that assigns and adjusts timing requirements for a time-constrained complex distributed system according to claim 1, wherein said timing requirement comprises:
a timeout value.

3. The timing management system and apparatus that assigns and adjusts timing requirements for a time-constrained complex distributed system according to claim 1, wherein said timing requirement comprises:
a total time elapsed parameter.

4. The timing management system and apparatus that assigns and adjusts timing requirements for a time-constrained complex distributed system according to claim 1, wherein:
said timing requirement is compiled into a timing policy message; and
said timing policy message is forwarded amongst a plurality of nodes of said time-constrained complex distributed system.

5. The timing management system and apparatus that assigns and adjusts timing requirements for a time-constrained complex distributed system according to claim 1, wherein:
said timing management node revises said timing requirement during request processing.

6. A method of assigning and adjusting a timing requirement for a time-constrained complex distributed system, comprising:
receiving, by a first of a plurality of nodes of a time-constrained complex distributed system, a system request;
forwarding, by said first of said plurality of nodes of said time-constrained complex distributed system, a timing query to a timing management node;
generating, by said timing management node, a timing requirement relevant to said system request for said time-constrained complex distributed system;
compiling, by said timing management node, said timing requirement relevant to said system request for said time-constrained complex distributed system, into a timing policy message;
transmitting, by said timing management node, said timing policy message to said first of said plurality of nodes of said time-constrained complex distributed system; and
forwarding, by said first of said plurality of nodes of said time-constrained complex distributed system, said timing policy message to a subsequent node of said plurality of nodes.

7. A method of assigning and adjusting a timing requirement for a time-constrained complex distributed system according to claim 6, further comprising:
forwarding said timing policy message by each remaining one of said plurality of nodes.

8. A method of assigning and adjusting a timing requirement for a time-constrained complex distributed system according to claim 7, further comprising:
determining, if said timing requirement received in said timing policy message on one of said plurality of nodes of said time-constrained complex distributed system, requires reconsideration from said timing management node.

9. A method of assigning and adjusting a timing requirement for a time-constrained complex distributed system according to claim 8, further comprising:
delivering, from said one of said plurality of nodes of said time-constrained complex distributed system, a timing query to said timing management node, if it is determined that a timing requirement received in said timing policy message on said one of said plurality of nodes of said time-constrained complex distributed system, requires reconsideration from said timing management node.

10. A method of assigning and adjusting a timing requirement for a time-constrained complex distributed system according to claim 9, further comprising:
dynamically determining, by said timing management node, if revised a timing requirement is necessary for said system request on said time-constrained complex distributed system, in response to said timing query.

11. A method of assigning and adjusting timing requirements for a time-constrained complex distributed system according to claim 9, further comprising:
delivering, by said timing management node, a revised timing policy message to said one of said plurality of nodes of said time-constrained complex distributed system in response to said timing query, when revised timing requirements are necessary for said system request on said time-constrained complex distributed system.
